(19) United States
(12) Patent Application Publication
(10) Pub. No.: US 2013/0046453 A1
(43) Pub. Date: Feb. 21, 2013

(54) SYSTEM AND METHOD FOR CONTROLLING MULTIPLE FUEL SYSTEMS

(71) Applicant: Joshua Cowgill, Hartland, MI (US)

(72) Inventor: Joshua Cowgill, Hartland, MI (US)

(73) Assignee: GM Global Technology Operations LLC, Detroit, MI (US)

(21) Appl. No.: 13/324,502

(22) Filed: Dec. 13, 2011

Related U.S. Application Data
(60) Provisional application No. 61/523,663, filed on Aug. 15, 2011.

(51) Int. Cl. F02D 41/30

(52) U.S. Cl. 701/104

(57) ABSTRACT

A system according to the principles of the present disclosure includes a fuel mass module and a fuel control module. The fuel mass module determines a first fuel mass before the first fuel mass is injected into one of a cylinder of an engine and an injection port of the cylinder. The fuel mass module also determines a second fuel mass after injection of the first fuel mass starts. The fuel control module controls a first fuel injector to inject the first fuel mass into the one of the cylinder and the injection port for a combustion event. The fuel control module also controls a second fuel injector to inject the second fuel mass into one of the cylinder and the injection port for the combustion event. The second fuel injector is different from the first fuel injector.

### CROSS-REFERENCE TO RELATED APPLICATIONS

This application claims the benefit of U.S. Provisional Application No. 61/523,663, filed on Aug. 16, 2011. The disclosure of the above application is incorporated herein by reference in its entirety.

This application is related to U.S. patent application Ser. No. ______ (attorney docket No. P017613) filed on ______, 2011, which claims the benefit of U.S. Provisional Application No. 61/523,677, filed on Aug. 16, 2011 and ______ (attorney docket No. P017601) filed on ______, 2011, which claims the benefit of U.S. Provisional Application No. 61/523,690 filed on Aug. 16, 2011. The disclosure of the above applications is incorporated herein by reference in their entirety.

### FIELD

The present disclosure relates to systems and methods for controlling multiple fuel systems in a vehicle.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Traditionally, an engine combusts a mixture of air and fuel delivered by one fuel system to generate drive torque for a vehicle. The air is drawn into the engine through a throttle valve and an intake manifold. The fuel is injected by one or more fuel injectors. The air/fuel mixture is combusted within one or more cylinders of the engine. Combustion of the air/fuel mixture may be initiated by, for example, injection of the fuel and/or spark provided by a spark plug. Combustion of the air/fuel mixture produces exhaust gas. The exhaust gas is expelled from the cylinders to an exhaust system.

A vehicle may include multiple fuel systems such as a direct injection system and a port injection system. A direct injection system injects fuel directly into a cylinder. A port injection system injects fuel into an injection port of a cylinder. Typically, only one of the fuel systems delivers fuel to the cylinder for a given combustion event.

### SUMMARY

A system according to the principles of the present disclosure includes a fuel mass module and a fuel control module. The fuel mass module determines a first fuel mass before the first fuel mass is injected into one of a cylinder of an engine and an injection port of the cylinder. The fuel mass module also determines a second fuel mass after injection of the first fuel mass starts. The fuel control module controls a first fuel injector to inject the first fuel mass into the one of the cylinder and the injection port for a combustion event. The fuel control module also controls a second fuel injector to inject the second fuel mass into one of the cylinder and the injection port for the combustion event. The second fuel injector is different from the first fuel injector.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine system according to the principles of the present disclosure;

FIG. 2 is a functional block diagram of an example engine control module according to the principles of the present disclosure; and

FIG. 3 is a flowchart illustrating an example method for controlling multiple fuel systems according to the principles of the present disclosure.

### DETAILED DESCRIPTION

A system and method according to the principles of the present disclosure controls more than one fuel system to deliver fuel to a cylinder for a single combustion event. For example, a port injection system may be controlled to inject fuel into an injection port of a cylinder for a combustion event, and a direct inject system may be controlled to inject fuel directly into the cylinder for the same combustion event. However, timing of the injections may be different depending on the type of fuel injected (e.g., gaseous, liquid) and the method of injection (e.g., port injection, direct injection).

The amount of fuel (e.g., the fuel mass) that each fuel system delivers to a cylinder may be determined before fuel is delivered to the cylinder, and the fuel mass may not be adjusted after fuel injection starts. The fuel mass may be determined based on the amount of air (e.g., the air mass) within the cylinder and a target air/fuel ratio such as a stoichiometric air/fuel ratio. The air mass may be estimated based on engine operating conditions. The engine operating conditions may include a mass flow rate of air flowing to an intake manifold, pressure within the intake manifold, and engine speed.

The engine operating conditions may change after fuel injection starts. Changes in the engine operating conditions may cause inaccuracies in the estimated air mass. In turn, the fuel masses injected by the fuel systems may not achieve the target air/fuel ratio.

A system and method according to the principles of the present disclosure continues to estimate the air mass and determines one or more of the fuel masses based on the air mass after fuel injection starts. A total mass of fuel delivered to the cylinder and a mass fraction injected by each fuel system may be determined before fuel injection starts. The total mass may be adjusted based on the air mass after fuel injection starts. The fuel mass of one or more initial injections may be determined based on the total mass and the mass fraction. The fuel mass of a final injection may be determined based on the total mass and the fuel mass already delivered.

Estimating the air mass after fuel injection starts improves the accuracy of the air mass by accounting for changes in the engine operating conditions. Determining the fuel mass after fuel injection starts enables achievement of the target air/fuel ratio. In turn, engine performance is improved and engine emissions are reduced.

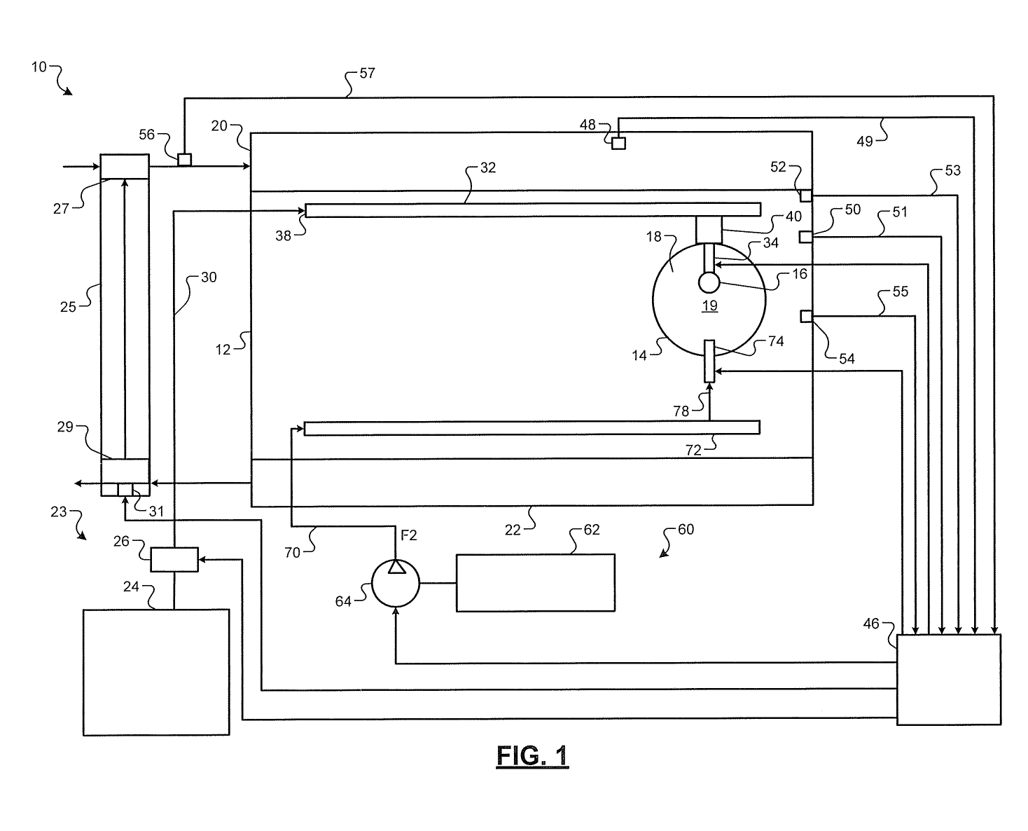

Referring now to the FIG. 1, a functional block diagram of an example engine system 10 is presented. The engine system 10 includes an engine 12, an intake manifold 20, an exhaust manifold 22, a first fuel system 23, and a second fuel system 60. Although the engine system 10 is depicted as including two fuel systems, the engine system 10 may include more than two fuel systems. The engine 12 may include an engine block that at least partially defines one or more cylinders, such as a cylinder 14. The engine 12 may include a cylinder head that defines one or more injection ports, such as an injection port 16. The cylinder head may also partially define the cylinders.

The cylinders and the cylinder head may collectively define combustion chambers, such as a combustion chamber 19. While the engine system 10 is illustrated as including only one cylinder, the engine system 10 may include multiple cylinders. The cylinders may be arranged in an inline configuration, a V-type configuration, or another suitable configuration.

Pistons, such as a piston 18, may be disposed within the cylinders for reciprocal displacement within the cylinders. Reciprocation of the pistons drives a crankshaft (not shown). The intake manifold 20 may be in communication with the combustion chambers to provide fresh airflow (indicated by arrow A) into the combustion chambers. The exhaust manifold 22 may be in communication with the combustion chambers to transport exhaust gases (indicated by arrow E) away from the combustion chambers.

A turbocharger 25 may be provided in various implementations. The turbocharger 25 includes a compressor (or impeller) 27 and a turbine 29. Exhaust flow drives rotation of the turbine 29. Rotation of the turbine 29 causes rotation of the compressor 27. The compressor 27 provides compressed air to the intake manifold 20. Opening of a wastegate 31 may be controlled to regulate an amount of exhaust bypassing the turbine 29 and/or the output of the compressor 27. The output of the compressor 27 may be controlled in another suitable manner for different types of turbochargers, such as variable nozzle turbochargers, variable vane turbochargers, etc. In various implementations, multiple turbochargers may be provided.

The first fuel system 23 includes a first fuel tank 24, a pressure regulator 26, a first fuel supply line 30, and a first fuel rail 32. The first fuel tank 24 may store a gaseous fuel such as liquefied petroleum gas (LPG), compressed natural gas (CNG), or hydrogen. Gaseous fuels are generally compressed within a fuel tank at greater than atmospheric pressure. The pressure regulator 26 may regulate flow (indicated by arrow F1) from the first fuel tank 24 to the first fuel rail 32. The pressure regulator 26 may include a pump, a valve, and/or other suitable components.

The first fuel rail 32 includes an inlet 38 where the first fuel rail 32 may receive gaseous fuel from the first fuel supply line 30. The first fuel rail 32 may receive gaseous fuel from the pressure regulator 26 and distribute gaseous fuel to gaseous fuel injectors, such as a gaseous fuel injector 34. A gaseous fuel injector may be provided for each cylinder/combustion chamber.

The first fuel rail 32 may also include fuel passageways, such as a fuel passageway 40. The gaseous fuel injector 34 receives gaseous fuel from the first fuel rail 32 via the fuel passageway 40. The gaseous fuel injector 34 (indirectly) provides the gaseous fuel to the combustion chamber 19. For example only, the gaseous fuel injector 34 may inject gaseous fuel into the injection port 16. Movement of the piston 18 within the cylinder 14 may create a vacuum that draws injected gaseous fuel from the injection port 16 into the combustion chamber 19.

The second fuel system 60 may include a second fuel tank 62, a fuel pump 64, a second fuel rail 72, and a second fuel supply line 70. A liquid fuel, such as gasoline or diesel, may be stored within the second fuel tank 62. The liquid fuel may be the same as or different from the gaseous fuel. In various implementations, gasoline (in liquid form) may also be used in place of the gaseous fuel and injected into the injection port 16. The fuel pump 64 may generate a fuel flow (indicated by arrow F2) from the second fuel tank 62 to the second fuel rail 72. The fuel pump 64 may be an electrical fuel pump or a mechanical fuel pump. In various implementations, one or more additional fuel pumps may be provided.

The second fuel rail 72 may distribute liquid fuel to liquid fuel injectors, such as a liquid fuel injector 74, via secondary fuel supply lines, such as a secondary fuel supply line 78. The liquid fuel injector 74 may inject liquid fuel directly into the combustion chamber 19. A liquid fuel injector may be provided for each combustion chamber (or each cylinder).

Engines where fuel is injected directly into the combustion chambers may be referred to as direct injection (DI) engines. In various types of engines, spark plugs (not shown) may be provided to initiate combustion of air and fuel within the combustion chambers. Engines where spark initiates combustion and fuel is injected directly into the combustion chambers may be referred to as spark ignition direct injection (SIDI) engines.

An engine control module (ECM) 46 receives input signals from a manifold absolute pressure (MAP) sensor 48, an engine coolant temperature (ECT) sensor 50, an engine oil temperature (EOT) sensor 52, a crankshaft position (CPS) sensor 54, and a mass airflow (MAF) sensor 56. The MAP sensor 48 measures pressure within the intake manifold 20 and generate a MAP signal 49 indicating the intake manifold pressure. The ECT sensor 50 measures the temperature of engine coolant and generates an ECT signal 51 indicating the engine coolant temperature.

The EOT sensor 52 measures the temperature of engine oil and generates an EOT signal 53 indicating the engine oil temperature. The CPS sensor 54 measures the position of the crankshaft and generates a CPS signal 55 indicating the crankshaft position. The MAF sensor 56 measures the mass flow rate of air flowing into the intake manifold 20 and generates a MAF signal 57 indicating the mass flow rate.

The ECM 46 controls the liquid fuel injector 74 to control the mass of liquid fuel injected into the combustion chamber 19 and the timing of the liquid fuel injection. The ECM 46 controls the gaseous fuel injector 34 to control the mass of gaseous fuel injected into the injection port 16 and the timing of the gaseous fuel injection. The ECM 46 may control the turbocharger 25, the pressure regulator 26, and the fuel pump 64.

The ECM 46 may control the injection of the gaseous and liquid fuels, for example, to achieve a target air/fuel ratio such as a stoichiometric air/fuel ratio. The ECM 46 may estimate the mass of air within the combustion chamber 19 and determine the fuel masses based on the air mass and the target air/fuel ratio. The ECM 46 may achieve the target air/fuel ratio by estimating the air mass and determining one or more of the fuel masses after fuel injection starts.

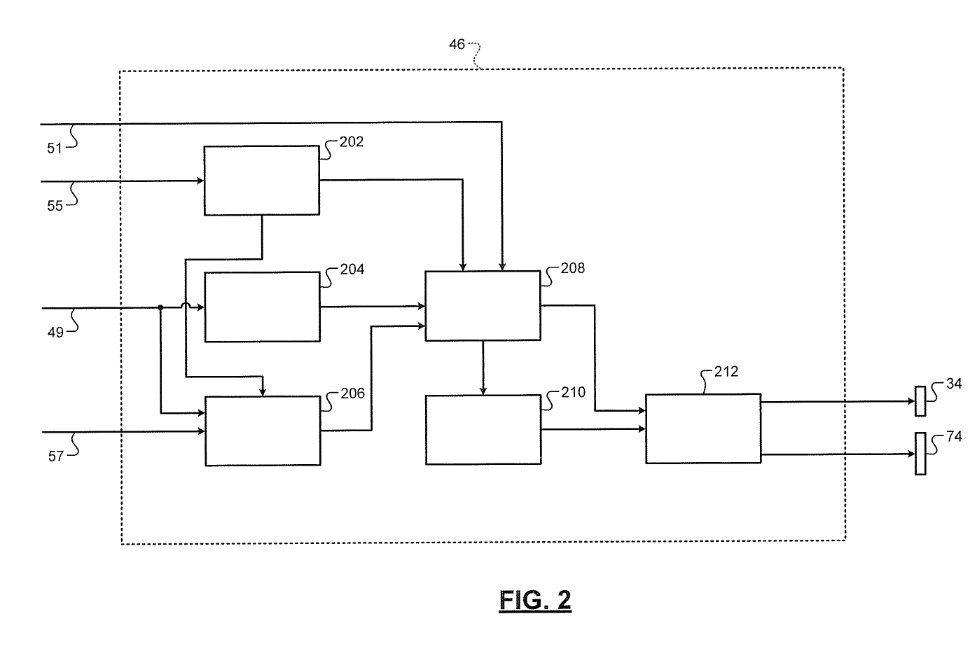

Referring now to FIG. 2, an example implementation of the ECM 46 includes an engine speed module 202, an engine load module 204, an air mass module 206, a fuel mass module 208, an injection timing module 210, and a fuel control module 212. The engine speed module 202 determines engine speed. The engine speed module 202 may determine the engine speed based on the crankshaft position indicated by the CPS signal 55. The engine speed module 202 outputs the engine speed.

The engine load module 204 determines engine load. The engine load module 204 may determine the engine load based on engine operating conditions such as the manifold pressure indicated by the MAP signal 49. The engine load module 204 may determine the engine load based on driver input such as accelerator pedal position. The engine load module 204 outputs the engine load.

The air mass module 206 estimates the amount of air (e.g., the air mass) within the cylinder 14 (or the combustion chamber 19) at the time of combustion. The air mass module 206 may estimate the air mass based on the engine speed, the mass flow rate indicated by the MAF signal 57, and/or the manifold pressure indicated by the MAP signal 49. For example, the air mass module 206 may determine volumetric efficiency based on the engine speed and estimate the air mass based on the volumetric efficiency. Volumetric efficiency is a ratio (or percentage) of the quantity of air that actually enters the cylinder 14 during induction to the quantity of air that the cylinder 14 is capable of containing under static conditions.

The air mass module 206 may assign different weights to the mass flow rate and the manifold pressure when estimating the air mass based on the mass flow rate and the manifold pressure. The weight assigned to the mass airflow may be greater when the engine 12 is operating at steady state, and the weight assigned to the manifold pressure may be greater when the engine 12 is operating at dynamic state. The engine 12 may be operating at steady state when the rate of change in the mass airflow and/or the manifold pressure is less than a predetermined rate. The engine 12 may be operating at dynamic state when the rate of change in the mass airflow and/or the manifold pressure is greater than or equal to the predetermined rate. The air mass module 206 outputs the air mass.

The fuel mass module 208 determines the amount of fuel (e.g., the fuel mass) injected by the first fuel system 23 for a combustion event and the fuel mass injected by the second fuel system 60 for the same combustion event. The fuel mass injected by the first fuel system 23 may be referred to as a first fuel mass. The fuel mass injected by the second fuel system 60 may be referred to as a second fuel mass.

The fuel mass module 208 may determine a total mass of fuel to be delivered to the cylinder 14 for the combustion event based on the air mass and a target air/fuel ratio such as a stoichiometric air/fuel ratio. Before fuel injection starts, the fuel mass module 208 may determine the first fuel mass and the second fuel mass based on the total mass and a mass fraction (or mass percentage). For example, the first fuel mass may be the product of the total mass and a first mass fraction, and the second fuel mass may be the product of the total mass and a second mass fraction.

The fuel mass module 208 may determine the first mass fraction based on engine operating conditions such as the engine speed, the engine load, and the engine coolant temperature. The fuel mass module 208 may determine the second mass fraction based on the first mass fraction. The fuel mass module 208 may ensure that the sum of the first mass fraction and the second mass fraction is equal to 1 (or 100 percent).

After fuel injection starts, the fuel mass module 208 may adjust the total mass based on the air mass and determine the second fuel mass based on the total mass and the mass of fuel delivered to the cylinder 14 (i.e., the delivered mass). The delivered mass may include fuel already delivered to the cylinder 14 and/or fuel being delivered to the cylinder 14. After injection of the first fuel mass starts and/or ends, and before injection of the second fuel mass starts, the fuel mass module 208 may determine the second fuel mass based on the difference between the total mass and the delivered mass.

After injection of the second fuel mass starts, the fuel mass module 208 may adjust the total mass based on the air mass and adjust the second fuel mass based on the difference between the total mass and the delivered mass. The delivered mass may include the first fuel mass and the portion of the second fuel mass that has been delivered. The fuel mass module 208 may continue to adjust the total mass and second fuel mass until injection of the second fuel mass ends. The fuel mass module 208 outputs the first fuel mass and the second fuel mass.

The discussion above applies when the first fuel mass is injected before the second fuel mass is injected. However, the second fuel mass may be injected before the first fuel mass, in which case the second fuel mass may be determined based on the engine operating conditions and the first fuel mass may be determined based on the second fuel mass. In addition, the first fuel mass may be adjusted after fuel injection starts in the manner described above with respect to the second fuel mass.

In addition, the engine system 10 may include more than two fuel systems, and the fuel mass module 208 may determine a fuel mass injected by each fuel system. The fuel mass of one or more initial injections may be determined based on the total mass and the mass fractions. The fuel mass of a final injection may be determined based on the total mass, as adjusted during fuel injection, and the delivered mass.

An injection timing module 210 determines injection timing of the first fuel mass and the second fuel mass. The injection timing module 210 may determine the injection timing based on the type of fuel injected (e.g., gaseous, liquid) and the method of injection (e.g., port injection, direct injection). For example, gasoline may be injected into the injection port 16 at a lower pressure than the pressure at which gasoline is injected into the cylinder 14. Thus, gasoline may be injected into the injection port 16 before gasoline is injected into the cylinder 14 to allow the gasoline to vaporize.

The injection timing module 210 may determine the injection timing based on the first fuel mass and the second fuel mass. The injection timing module 210 may determine a pulse width of each injection based on the mass injected. The injection timing module 210 may determine a start position (i.e., a crankshaft position when injection starts) based on the pulse width and an end position (i.e., a crankshaft position when injection ends), and the end position may be predetermined. Alternatively, the injection timing module 210 may determine the end position based on the pulse width and the start position, and the start position may be predetermined. For example, the end position of a port injection may correspond to before the intake valve opens, and the end position of a direct injection may correspond to after the intake valve opens. The injection timing module 210 outputs the injection timing.

The fuel control module 212 controls the gaseous fuel injector 34 to inject the first fuel mass into the injection port 16 according to the injection timing. The fuel control module 212 controls the liquid fuel injector 74 to inject the second fuel mass into the combustion chamber 19 (or the cylinder 14) according to the injection timing. The fuel mass module 208 may adjust the second fuel mass after the gaseous fuel injector 34 starts injecting the first fuel mass and continue to adjust the second fuel mass until the liquid fuel injector 74 stops injecting the second fuel mass.

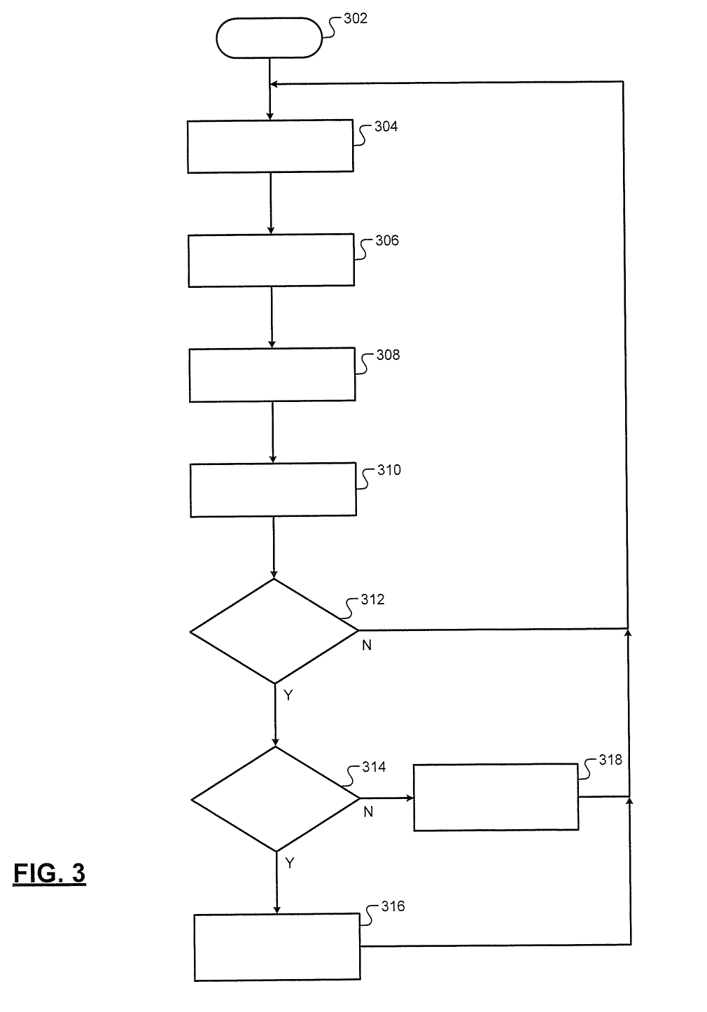

Referring now to FIG. 3, a method for controlling multiple fuel systems to inject fuel into an engine for a single combustion event starts at 302. At 304, the method estimates an amount of air (i.e., an air mass) within a cylinder of the engine at the time of combustion. Before fuel is delivered to the cylinder, the method may estimate the air mass based on engine speed. After fuel delivery to the cylinder starts, the method may estimate the air mass based on a mass flow rate of air flowing to an intake manifold and/or pressure within the intake manifold.

At 306, the method determines a total mass of fuel to be delivered to the cylinder by the multiple fuel systems. The method may determine the total mass based on the air mass and a target air/fuel ratio such as a stoichiometric air fuel ratio. At 308, the method determines a mass fraction for each injection. The method may determine the mass fraction based on engine speed, engine load, and/or engine coolant temperature.

At 310, the method determines injection timing for each injection. The method may determine the injection timing based on the type of fuel injected (e.g., gaseous, liquid) and/or the method of injection (e.g., port injection, direct injection). At 312, the method determines whether it is time to inject fuel into the engine. The method may determine when to inject based on the injection timing and crankshaft position. If 312 is true, the method continues at 314. Otherwise, the method continues at 304.

At 314, the method determines whether the injection timing corresponds to a final injection of multiple injections. If 314 is true, the method continues at 316. Otherwise, the method continues at 318. At 316, the method determines the fuel mass based on the total mass and the mass fraction. At 318, the method determines the fuel mass based on the total mass and the fuel mass already delivered to the cylinder.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. A system comprising:
a fuel mass module that: (i) determines a first fuel mass before the first fuel mass is injected into one of a cylinder of an engine and an injection port of the cylinder; and (ii) determines a second fuel mass after injection of the first fuel mass starts; and
a fuel control module that: (i) controls a first fuel injector to inject the first fuel mass into the one of the cylinder and the injection port for a combustion event; and (ii) controls a second fuel injector to inject the second fuel mass into one of the cylinder and the injection port for the combustion event, wherein the second fuel injector is different from the first fuel injector.

2. The system of claim 1, wherein the fuel mass module determines the second fuel mass after injection of the first fuel mass ends.

3. The system of claim 1, wherein the fuel mass module adjusts the second fuel mass after injection of the second fuel mass starts.

4. The system of claim 1, wherein the first fuel injector injects the first fuel mass into the injection port and the second fuel injector injects the second fuel mass directly into the cylinder.

5. The system of claim 1, wherein the first fuel injector injects a gaseous fuel and the second fuel injector injects a liquid fuel.

6. The system of claim 1, wherein the fuel mass module determines the first fuel mass based on a total mass of fuel to be delivered to the cylinder and a mass fraction.

7. The system of claim 6, wherein the fuel mass module determines the second fuel mass based on a delivered mass of fuel delivered to the cylinder and the total mass.

8. The system of claim 6, wherein the fuel mass module determines the mass fraction based on at least one of engine speed, engine load, and engine coolant temperature.

9. The system of claim 6, wherein the fuel mass module determines the total mass based on an air mass within the cylinder and a target air/fuel ratio.

10. The system of claim 9, further comprising an air mass module that estimates the air mass based on at least one of a mass flow rate of air flowing to an intake manifold of the engine, pressure within the intake manifold, and engine speed.

11. A method comprising:
determining a first fuel mass before the first fuel mass is injected into one of a cylinder of an engine and an injection port of the cylinder;
determining a second fuel mass after injection of the first fuel mass starts;
controlling a first fuel injector to inject the first fuel mass into the one of the cylinder and the injection port for a combustion event; and
controlling a second fuel injector to inject the second fuel mass into one of the cylinder and the injection port for the combustion event, wherein the second fuel injector is different from the first fuel injector.

12. The method of claim 11, further comprising determining the second fuel mass after injection of the first fuel mass ends.

13. The method of claim 11, further comprising adjusting the second fuel mass after injection of the second fuel mass starts.

14. The method of claim 11, further comprising controlling the first fuel injector to inject the first fuel mass into the injection port and controlling the second fuel injector to inject the second fuel mass directly into the cylinder.

15. The method of claim 11, further comprising controlling the first fuel injector to inject a gaseous fuel and controlling the second fuel injector to inject a liquid fuel.

16. The method of claim 11, further comprising determining the first fuel mass based on a total mass of fuel to be delivered to the cylinder and a mass fraction.

17. The method of claim 16, further comprising determining the second fuel mass based on a delivered mass of fuel delivered to the cylinder and the total mass.

18. The method of claim 16, further comprising determining the mass fraction based on at least one of engine speed, engine load, and engine coolant temperature.

19. The method of claim 16, further comprising determining the total mass based on an air mass within the cylinder and a target air/fuel ratio.

20. The method of claim 19, further comprising estimating the air mass based on at least one of a mass flow rate of air flowing to an intake manifold of the engine, pressure within the intake manifold, and engine speed.
